(19) United States
(12) Patent Application Publication
(10) Pub. No.: US 2015/0048575 A1
(43) Pub. Date: Feb. 19, 2015

(54) NOVEL CERAMIC-TO-METAL SEAL, AND METHOD FOR PRODUCING SAME

(71) Applicant: L'Air Liquide, Societe Anonyme Pour l'Etude et l' Exploitation des Procedes Georges Claude, Paris (FR)

(72) Inventors: Gilles Lebain, Thiais (FR); Nicolas Richet, Fontenay Le Fleury (FR)

(21) Appl. No.: 14/384,927

(22) PCT Filed: Jan. 31, 2013
(86) PCT No.: PCT/FR2013/050204

§ 371 Date: Sep. 12, 2014

(30) Foreign Application Priority Data
Mar. 12, 2012 (FR) 1252181

(51) Int. Cl. F16J 15/10; C04B 37/02

(52) U.S. Cl. CPC F16J 15/102; C04B 37/025; C04B 2237/84; C04B 2237/10
USPC 277/627; 156/293; 277/602

(57) ABSTRACT

The invention relates to a seal assembly, which includes: (a) a ceramic tube (1); (b) a first ring (2) made of a refractory alloy including: a cylindrical opening (21) for receiving the ceramic tube; a first shoulder (22) which is located at the lower end of the ring, which is directed towards the interior of the cylindrical opening and which enables said ceramic tube to be supported; a second shoulder (23) forming, at the upper end of the ring, an annular space between the ceramic tube and the first ring made of a refractory alloy; (c) a second ring (3) which is made of a material that can be deformably sealed by heat-treatment, and which is located in the annular space formed by the second shoulder of the ring made of a refractory material; and (d) a third ring (4) made of a metal alloy, which is positioned on the upper edge of the first ring (2).

The invention relates to the field of ceramic-to-metal seals and more specifically to the seal between a ceramic and a metal or metal alloy, that ensures gas tightness for the longest possible duration, under an oxidizing atmosphere on one side and a reducing atmosphere on the other side, or under a neutral atmosphere on one side and a vacuum on the other side, with a pressure difference between the two atmospheres of between 0 and 30 bar. The atmospheres are capable of containing steam and the assembly must operate in a temperature range between 20° C. and 1000° C. These constraints impose the use of materials that are chemically inert with respect to one another and that possess suitable physical properties.

The targeted applications are ceramic membrane reactors for gas production or separation, in particular the CMR (catalytic membrane reactor) for the production of syngas.

Two main approaches have already been studied.

The first approach consists in compressing a deformable material which presses against the metal on one side and against the ceramic on the other side. The seal is subjected to compressive forces that enable it to ensure good contact at the interfaces and leak tightness (documents U.S. Pat. No. 6,547,286 and EP 1 067 320). An important point is to limit the stresses applied to the ceramic tube in order to avoid damaging it. In most cases, a fluid phase is necessary in order to perfect the gas tightness of the seal, in particular if the surface finishes of the parts are very irregular. A ceramic-to-metal seal consisting of a multilayer stack of mica and glass has been developed: Chou, Y- S., Stevenson, J. W., Thermal cycling and degradation mechanisms of compressive mica-based seals for solid oxide fuel cells, 2002, J. of Power Sources, vol. 112, p. 376-383. However, the difference in thermal expansion coefficients is large between the mica (6.9×10⁻⁶/° C.) and the chosen alloys (Inconel 600=19×10⁻⁶/° C., SS430=12.5×10⁻⁶/° C.), which leads to a rapid increase in leakages during relatively rapid thermal cycles between 100° C. and 800° C., despite the good leak tightness provided by the glass. In the absence of glass, high compression of the deformable material is necessary to obtain good leak tightness.

Another solution is to wind a fiber round the ceramic tube and to ensure a compression between the fiber and the metal support. A fluid phase may also be added in order to perfect the gas tightness of the seal. This type of connection requires having perfect matching of the thermal expansion coefficients of the support and of the tube since there is intimate contact between the two parts and the deformations of the metal are very small with the designs proposed. Repeated thermal cycles or thermal shocks (rapid temperature variation) or chemical shocks (rapid variation of the oxygen content of the atmosphere) could result in the tube cracking. Furthermore, this design makes it necessary to produce tubes with an open end that is conical, which requires them to be produced by pressing. Other metal support designs that can be used with straight tubes have been developed, but they impose radial stresses on the ceramic in order to ensure the leak tightness and here too the thermal expansion coefficients of the components of the seal must be perfectly matched (U.S. Pat. No. 6,454,274, U.S. Pat. No. 6,139,810).

In the case of ceramic membranes, it is also necessary to consider the so-called chemical expansion linked to the change in concentration of oxygen vacancies in the ceramic as a function of the atmosphere. These dimensional changes are most critical for the operation of ceramic membrane reactors.

Hence, one problem that is faced is to provide a better ceramic-to-metal seal assembly for tubular ceramic membranes.

One solution of the present invention is a seal assembly that comprises:
(a) a ceramic tube 1
(b) a first ring 2 made of a refractory alloy comprising:
   a cylindrical opening 21 that makes it possible to receive the ceramic tube;
   a first shoulder 22 located at the lower end of the ring, oriented toward the inside of the cylindrical opening and making it possible to support said ceramic tube;
   a second shoulder 23 that forms an annular space, at the upper end of the ring, between the ceramic tube and the first ring made of a refractory alloy;
(c) a second ring 3 made of a sealing material that can be deformed by heat treatment, located in the annular space formed by the second shoulder of the refractory alloy ring; and
(d) a third ring 4 made of a metal alloy positioned on the upper edge of the first ring 2.

A representation of the seal assembly according to the invention is represented in FIG. 1.

The seal assembly according to the invention makes it possible:
to reduce the scrap rate by ensuring the uniformity of the distribution of the sealing material over the circumference of the membrane, which prevents the risks of leakages in the regions that are low in sealing material;
to limit the mechanical stresses developed across the membrane during creation of the sealing and during the use of the membrane;
to improve the sealing performances by forming a barrier between the sealing material and the surrounding atmosphere in order to avoid the direct exposure thereof to corrosive gases.

Depending on the case, the assembly according to the invention may have one or more of the following features:
said assembly has a first gap, between the ceramic tube and the lower portion at the second shoulder 23 of the first ring 2, of less than 0.2 mm; -said assembly has a second gap, between the ceramic tube 1 and the second ring 3, of less than 0.1 mm;
the sealing material of the second ring 3 is chosen from glasses and glass-ceramics;
the alloys of the first ring 2 and of the third ring 4 are chosen from alloys having a service temperature above 500° C. and a thermal expansion coefficient from ambient temperature to 800° C. of greater than 12×10⁻⁶ K⁻¹, such as for example the alloys Haynes ® 230, HR 120, 690, 601, 800 HT, etc. Preferably, the first ring 2 and the third ring 4 are made from the same alloy;
the second ring 3 comprises a shoulder 31 that makes it possible to support the third ring 4;
said assembly has a second gap, between the ceramic tube 1 and the second ring 3, of less than 0.2 mm;
a portion 42 of the third ring 4 is located in the annular space formed by the second shoulder 23 of the first ring 2 made of a refractory alloy.

The first ring made of a refractory alloy makes it possible to ensure the leak tightness, on one side with the ceramic membrane and on the other side with the reactor. It consists of two regions, the first is a ceramic-to-metal bond which is the subject of this invention and the second is a metal-to-metal bond which ensures the leak tightness with the reactor by a known technique of compression seal or plane/plane contact type.

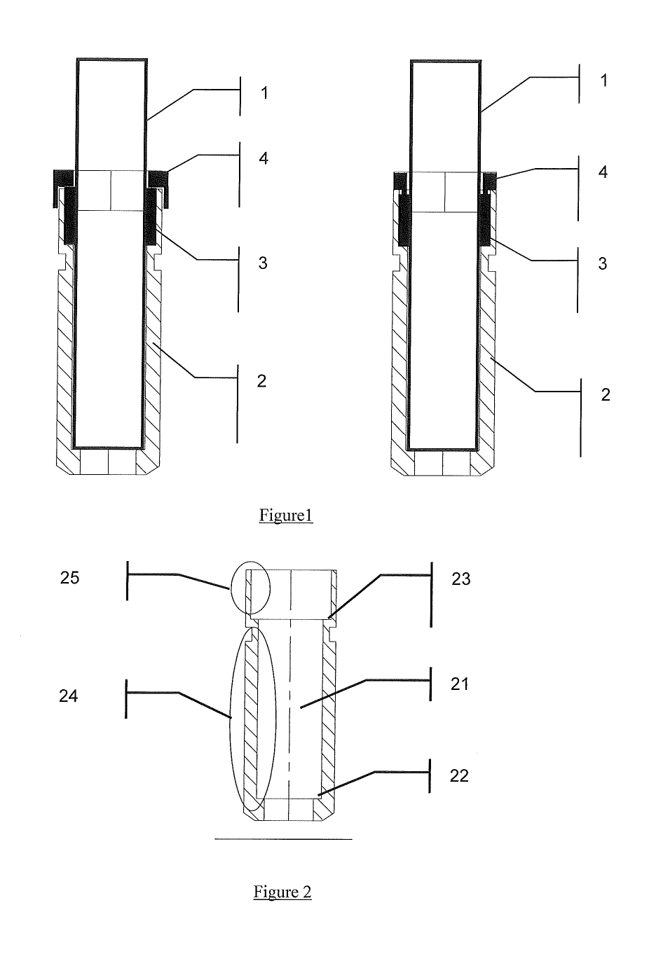

At the ceramic/metal join, that is to say at the join with the ceramic tube, this ring has two functions (FIG. 2):
guiding and supporting the ceramic tube in order to keep it as vertical as possible, reference will be made to the guiding zone 24; and
the formation of a leak tight and stable interface between the refractory alloy that constitutes it and the sealing material, reference will be made to the sealing zone 25.

The drawing presented in FIG. 2 shows the two shoulders, the first on which the ceramic membrane is placed, the second serving as a support for the sealing material. The diameter and the height of this ring are adjusted to the dimensions of the membrane. In order to limit the costs, it is possible to choose to leave the sides of the first ring fixed despite the slight dimensional variations of the ceramic membranes.

The second ring made of a sealing material is deformed during a high-temperature heat treatment in order to force it to occupy the whole of the volume between the membrane and the ring for connection to the reactor. The expression “heat treatment” is understood, for example, to mean the application of a temperature of the order of:
1150° C. for a sealing material made of Macor® glass-ceramic,
850° C. for a sealing material made of soda-lime glass, or
1100° C. for a sealing material made of glass that is filled to 20 wt % with ceramic (Al₂O₃, ZrO₂, perovskite, etc.) particles.

The second ring 3 used within the context of the present invention may or may not have a shoulder 31 intended for supporting the third ring.

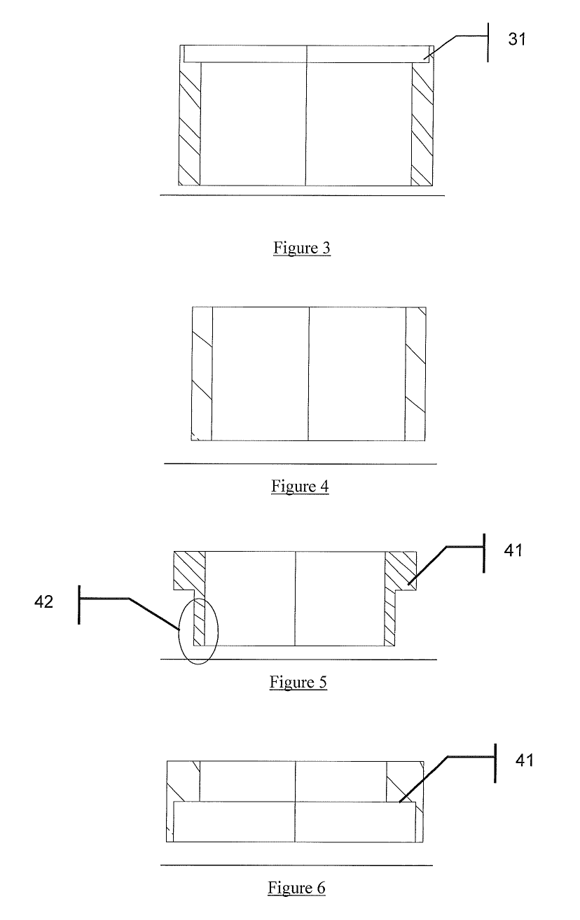

FIG. 3 represents the second ring with the shoulder 31 and FIG. 4 represents the second ring without the shoulder.

In the case where the second ring 3 has a shoulder 31, this ring carries out three functions:
guiding and centering the ceramic tube with respect to the first ring with the reactor. For this, the gap between the external diameter of the ceramic tube and the internal diameter of this ring must be less than 0.2 mm. This makes it possible to keep the ceramic tube vertical and to ensure a good distribution of the sealing material over the circumference of the membrane. The gap with the first ring, toward the reactor, is less than 0.1 mm. The join between the first ring and the reactor may be achieved by welding, diffusion welding, brazing, metal gasket, etc.;
centering the third ring, which also makes it possible to ensure a uniform distribution of the sealing material over the circumference of the membrane and greatly increases the reliability and reproducibility of the sealing;
establishing leak tight interfaces with the ceramic tube and the first ring with the reactor. For this, the gaps between these parts are minimized as much as possible in order to ensure rapid and intimate contact at the interfaces during the deformation of the sealing material at high temperature.

The volume of the second ring 3 is also an important parameter. It must be adjusted as a function of the volume available when all the components have reached their final position (the sealing material is deformed and the second ring follows this deformation). This makes it possible to prevent an overflow of the sealing material when it is fluid. The volume is adjusted by adjusting the height of the part.

The volume of the second ring will preferably be slightly underestimated in order to avoid the risks mentioned above while bearing in mind that obtaining leak tightness requires sufficient sealing material.

When the second ring does not have a shoulder (FIG. 4), this ring only carries out two functions:
guiding and centering the ceramic tube with respect to the first ring with the reactor. For this, the gap between the external diameter of the ceramic tube and the internal diameter of this second ring must be less than 0.1 mm. This makes it possible to keep the ceramic tube vertical and to ensure a good distribution of the sealing material over the circumference of the ceramic tube; and
establishing leak tight interfaces with the ceramic tube and the first ring with the reactor. For this, the gaps between these parts are minimized as much as possible in order to ensure rapid and intimate contact at the interfaces during the deformation of the sealing material at high temperature.

The third ring is essential for obtaining leak tight sealing, for reproducibility and for limiting the stresses in the ceramic tube.

Indeed, the third ring carries out four functions:
ensuring uniform spreading of the sealing material over the circumference of the ceramic tube;
preventing the adhesive bonding of the optional load placed on the sealing material during the creation of the join in order for the deformation to be uniform;
limiting the load applied to the membrane once the sealing is achieved since this ring is placed on the first ring toward the reactor; and
protecting the sealing material with respect to the surrounding atmosphere (corrosion resistance).

The third ring can be chosen from one of the following two shapes. The first shape is illustrated in FIG. 5 and is combined with the second ring made of sealing material from FIG. 3, in other words the second ring 3 which has a shoulder 31. The principle consists in penetrating the third ring into the sealing material in order to force it to flow toward the interfaces. FIG. 5 shows the portion 42 that penetrates into the sealing material. The height of penetration of the third ring into the sealing material must be sufficient to ensure uniform spreading of the latter without reaching the full height of the sealing region. It will also influence the volume to be filled in by the sealing material, and therefore the height of the second ring of sealing material.

The second shape is illustrated in FIG. 6 and is combined with the second ring made of sealing material from FIG. 4. In this case, the volume to be filled in by the sealing material is independent of the shape of the second ring, therefore the dimensions of the second ring made of sealing material are independent of those of the third ring. The guiding and centering of the third ring are provided by the outside of the ring for connection with the reactor. The second ring made of sealing material has a simpler shape than in the preceding system.
In both cases, a shoulder 41 is produced in order to form a barrier with respect to the surrounding atmosphere.

Another subject of the present invention is a process for producing the seal assembly according to the invention, comprising the following successive steps:
a) the ceramic tube 1 is introduced into the cylindrical opening 21 of the first ring 2 made of a refractory alloy;
b) the sealing material is introduced into the annular space formed by the second shoulder 23 of the first ring 2 made of a refractory alloy;
c) the third ring 4 is deposited on the upper edge of the second ring 3; and
d) a heat treatment is applied to the assembly of the three rings 2, 3 and 4 and to the ceramic tube 1, at a temperature that enables the sealing material to be deformed;
e) a seal assembly according to invention is recovered.

When the heat treatment is applied, the sealing material is deformed in order to force it to occupy the whole of the annular space formed by the second shoulder 23 of the first ring 2 made of a refractory alloy and to enable the third ring to be positioned on the upper edge of the first ring 2.

In the case where:
the third ring 4 comprises a shoulder 41 that enables the third ring 4 to be positioned on the first ring 2, and
the second ring has a shoulder 23 and a portion of the third ring is located in the annular space formed by the second shoulder 23 of the refractory alloy ring,
   the process for producing the seal assembly comprises the following successive steps:
a) the ceramic tube 1 is introduced into the cylindrical opening 21 of the first ring 2 made of a refractory alloy;
b) the sealing material is introduced into the annular space formed by the second shoulder 23 of the first ring 2 made of a refractory alloy;
c) the third ring 4 is put in place by introducing one portion 42 into the annular space formed by the second shoulder 23 of the first ring 2 so as to spread the sealing material into the annular space and by positioning the shoulder of the third ring 4 on the edge of the second ring 3; and
d) a heat treatment is applied to the assembly of the three rings 2, 3 and 4 and to the ceramic tube 1, at a temperature that enables the sealing material to be deformed;
e) a seal assembly according to invention is recovered.

In this case too, when the heat treatment is applied, the sealing material is deformed in order to force it to occupy the whole of the annular space formed by the second shoulder 23 of the first ring 2 made of a refractory alloy and to enable the third ring to be positioned on the upper edge of the first ring 2.

Depending on the case, the process according to invention may have one or more of the features below:
before or during the heat treatment step d), a load 71 is applied to the third ring 4;
the heat treatment is carried out in air;
the heat treatment is carried out using a furnace.

Before step a) of introducing the ceramic tube, it is possible to add a step of pre-oxidation of the metal alloy rings. This is a treatment in air at 950° C. for 2 h to form a glassy layer at the surface in order to improve the anchorage between the sealing material and the surface of the metal alloy.

The first ring 2 could also be sandblasted before step a). The expression “sandblasted” is understood to mean an increase of the surface roughness in the region which is in contact with the sealing material, in other words at the annular space. This being in order to improve the adhesion of the sealing material to the surface of the alloy by mechanical anchorage of the sealing material in the roughness created.

Note that the heat treatment could be applied solely in the region of the sealing material.

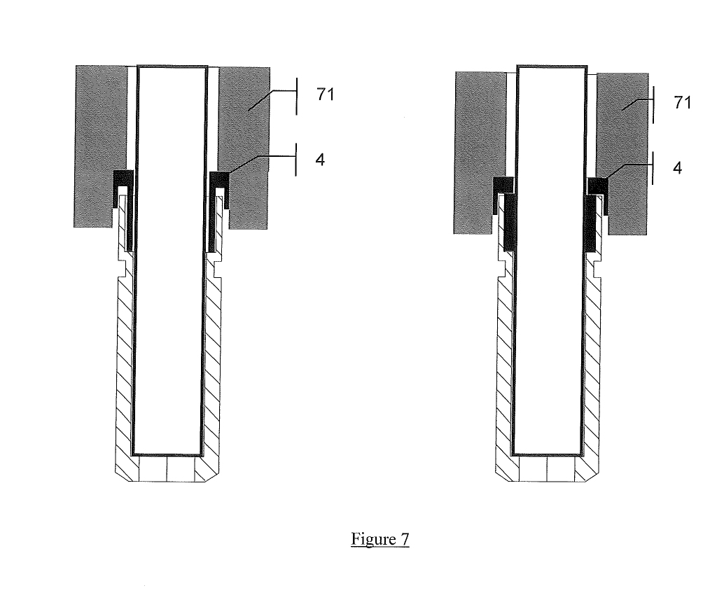

The application of a load to the third ring makes it possible to ensure a uniform deformation over the circumference of the membrane. This load may be applied in several ways:
The simplest consists in positioning a solid part on the third ring 4 (FIG. 7). Despite its simplicity, this technique makes it possible not to apply stress directly to the ceramic tube 1, which could damage it. Indeed, the load initially rests solely on the third ring 4 and the second ring 3 made of a sealing material (left-hand part of FIG. 7). During the heat treatment, the deformation of the sealing material results in the third ring being positioned over the shoulder of the first ring 2 with the reactor (right-hand part of FIG. 7). On cooling, the load is therefore applied to the first ring 2 toward the reactor via the third ring 4. At no moment of the process is the load applied directly or indirectly to the ceramic tube 1. This makes it possible to prevent any damaging of the ceramic tube during the sealing step.
Another solution would be to use a press in the furnace in order to apply the load at the desired moment during the sealing. This technically possible approach uses means that are more expensive than the first solution.

The heat treatment used for obtaining the deformation of the sealing material must be adjusted as a function of the latter. For this type of application, the best candidates for the sealing material are glasses and glass-ceramics. It is therefore advisable to know their spreading property (viscosity as a function of temperature) in order to adjust the maximum temperature of the treatment, the hold time necessary at this temperature and the cooling rates and holds necessary during cooling in order to limit the stresses during this step.

The seal assembly according to the invention will preferably be used within a ceramic membrane reactor for gas production or separation, preferably for the production of syngas or for the production of electricity by oxy-fuel combustion of coal.

1. A seal assembly that comprises:
(a) a ceramic tube (1);
(b) a first ring (2) made of a refractory alloy comprising:
a cylindrical opening (21) that makes it possible to receive the ceramic tube;
a first shoulder (22) located at the lower end of the ring, oriented toward the inside of the cylindrical opening and making it possible to support said ceramic tube;
a second shoulder (23) that forms an annular space, at the upper end of the ring, between the ceramic tube and the first ring made of a refractory alloy;
(c) a second ring (3) made of a sealing material that can be deformed by heat treatment, located in the annular space formed by the second shoulder of the refractory alloy ring; and
(d) a third ring (4) made of a metal alloy positioned on the upper edge of the first ring (2).

2. The assembly according to claim 1, wherein said assembly has a first gap, between the ceramic tube and the lower portion at the second shoulder (23) of the first ring (2), of less than 0.2 mm.

3. The assembly according to claim 1, wherein said assembly has a second gap, between the ceramic tube (1) and the second ring (3), of less than 0.1 mm.

4. The assembly according to claim 1, wherein the sealing material of the second ring (3) is chosen from glasses and glass-ceramics.

5. The assembly according to claim 1, wherein the alloys of the first ring (2) and of the third ring (4) are chosen from alloys having a service temperature above 500° C. and a thermal expansion coefficient from ambient temperature to 800° C. of greater than 12×10⁻⁶ K⁻¹.

6. The assembly according to claim 1, wherein the second ring (3) comprises a shoulder (31) that makes it possible to support the third ring (4).

7. The assembly according to claim 6, wherein said assembly has a second gap, between the ceramic tube (1) and the second ring (3), of less than 0.2 mm.

8. The assembly according to claim 6, wherein the third ring (4) comprises a shoulder (41) that enables the third ring (4) to be positioned on the first ring (2).

9. The assembly according to claim 8, wherein a portion (42) of the third ring (4) is located in the annular space formed by the second shoulder (23) of the first ring (2) made of a refractory alloy.

10. A process for producing the seal assembly as defined claim 1, comprising the following successive steps:
a) the ceramic tube (1) is introduced into the cylindrical opening (21) of the first ring (2) made of a refractory alloy;
b) the sealing material is introduced into the annular space formed by the second shoulder (23) of the first ring (2) made of a refractory alloy;
c) the third ring (4) is deposited on the upper edge of the second ring (3); and
d) a heat treatment is applied to the assembly of the three rings (2), (3), and (4) and to the ceramic tube (1), at a temperature that enables the sealing material to be deformed;
e) a seal assembly as defined in one of claims 1 to 5 is recovered.

11. A process for producing the seal assembly according to claim 9, comprising the following successive steps:
a) the ceramic tube (1) is introduced into the cylindrical opening (21) of the first ring (2) made of a refractory alloy;
b) the sealing material is introduced into the annular space formed by the second shoulder (23) of the first ring (2) made of a refractory alloy;
c) the third ring (4) is put in place by introducing one portion (42) into the annular space formed by the second shoulder (23) of the first ring (2) so as to spread the sealing material into the annular space and by positioning the shoulder of the third ring (4) on the edge of the second ring (3); and
d) a heat treatment is applied to the assembly of the three rings (2), (3), and (4) and to the ceramic tube (1), at a temperature that enables the sealing material to be deformed;
e) a seal assembly as defined in claim 9 is recovered.

12. The process according to one of claims 10 or 11, characterized in that before or during the heat treatment step d), a load (71) is applied to the third ring (4).

13. The process according to claim 10, wherein the heat treatment is carried out in air.

14. The process according to claim 10, wherein the heat treatment is carried out using a furnace.

15. The process according to claim 11, wherein the heat treatment is carried out in air.

16. The process according to claim 11, wherein the heat treatment is carried out using a furnace.
